(19) United States
(12) Patent Application Publication
(10) Pub. No.: US 2019/0001345 A1
(43) Pub. Date: Jan. 3, 2019

(54) PARTICLE FILTERING APPARATUS

(71) Applicant: Tassu ESP Oy, Mikkeli (FI)

(72) Inventors: Ari LAITINEN, Tampere (FI); Heikki SUHONEN, Kuopio (FI); Seppo PAAVILAINEN, Mikkeli (FI); Jorma KESKINEN, Tampere (FI); Juha TIKKANEN, Tampere (FI)

(21) Appl. No.: 16/021,316

(22) Filed: Jun. 28, 2018

Related U.S. Application Data
(60) Provisional application No. 62/525,935, filed on Jun. 28, 2017.

(51) Int. Cl. B03C 3/38; B03C 3/47; B03C 3/41

(52) U.S. Cl. CPC B03C 3/38; B03C 2201/06; B03C 3/41; B03C 3/47

(57) ABSTRACT

A gas cleaning apparatus includes:
an ion source to provide an ion beam,
a charging zone to form charged particles by exposing particles of a particle-laden gas to the ion beam, and
a filter element to collect the charged particles,
   wherein the ion source includes a corona electrode to generate ions by a corona discharge, the ion source is arranged to form the corona discharge in a protective gas, and wherein the apparatus is arranged to form the ion beam by using an electric field to draw the generated ions from the corona discharge to the particle-laden gas.

### FIELD

Some versions relate to removing particles from a gas.

### BACKGROUND

It is known that an electrostatic precipitator may comprise a corona wire and metal plates. Particles of a particle-laden gas are charged by generating a corona discharge in the particle-laden gas. The charged particles are subsequently collected from the gas to the metal plates by an electric field.

### SUMMARY

Some versions may relate to an apparatus for removing particles from a gas. Some versions may relate to a method for removing particles from a gas.

According to an aspect, there is provided a gas cleaning apparatus (500), comprising:
an ion source (100) to provide an ion beam (JB1),
a charging zone (CHRZ1) to form charged particles (P1) by exposing particles (P0) of a particle-laden gas (FG0) to the ion beam (JB1), and
a filter element (FIL2) to collect the charged particles (P1), wherein the ion source (100) comprises a corona electrode (ELEC1) to generate ions (J1) by a corona discharge (DSR1), the ion source (100) is arranged to form the corona discharge (DSR1) in a protective gas (AG1), and wherein the apparatus (500) is arranged to form the ion beam (JB1) by using an electric field (EF1) to draw the generated ions (J1) from the corona discharge (DSR1) to the particle-laden gas (FG0).

The ion beam may be formed from ions, which are drawn from the corona discharge towards the filter element via the protective gas. In particular, the corona discharge may be surrounded by a protective gas stream.

The corona electrode may be arranged to operate in a particle-free gas stream, which may protect the corona electrode from particles, moisture and/or corrosion. The corona discharge may be completely surrounded by the protective gas during operation. Thus, formation of ions in the corona discharge may be substantially independent of the composition and velocity of the particle-laden gas.

Formation of ions in the corona discharge may be controlled e.g. by selecting the strength of the electric field, the composition of the protective gas stream and/or the flow velocity of the protective gas stream.

The protective gas stream may reduce or prevent contamination of the corona electrode. The protective gas stream may improve operating reliability of the filtering apparatus. The protective gas stream may reduce the need for maintenance of the apparatus. The protective gas stream may reduce the need for cleaning the apparatus. The protective gas stream may reduce operating costs of the apparatus.

The particles may comprise combustible material, e.g. oil. The corona discharge may be completely surrounded by the protective gas. Consequently, the risk of igniting a fire in the apparatus may be substantially reduced.

The corona electrode may generate the ions, and the same corona electrode may also generate an electric field, for pushing the generated ions and the charged particles towards the filter element. Consequently, the number of electrically insulating high voltage feedthroughs may be reduced or minimized. This may improve operating reliability of the apparatus.

The velocity of the ions accelerated by the electric field may be substantially higher than the velocity of the protective gas stream. Consequently, the flow rate of the protective gas stream may be small when compared with the total flow rate of the particle-laden gas flow. The total flow rate of the protective gas of the apparatus may be e.g. in the range of 0.1% to 1% of the total flow rate of the particle-laden gas. The flow rate protective gas through a single nozzle may be e.g. in the range of 5 to 30 standard liters per minute. The flow rate protective gas through a single nozzle may be e.g. in the range of 5 to 10 standard liters per minute.

### BRIEF DESCRIPTION OF THE DRAWINGS

In the following examples, several variations will be described in more detail with reference to the appended drawings, in which

FIG. 1a shows, by way of example, in a cross sectional side view, a filtering apparatus,

FIG. 1b shows, by way of example, in a cross sectional side view, the filtering apparatus,

FIG. 2a shows, by way of example, in cross sectional a side view, an ion source unit,

FIG. 2b shows, by way of example, in a cross sectional side view, an ion source unit,

FIG. 2c shows, by way of example, in a cross sectional side view, an ion source unit, which comprises several corona electrodes,

FIG. 2d shows, by way of example, in a cross sectional side view, an ion source unit, which comprises several corona electrodes,

FIG. 3a shows, by way of example, in a cross sectional side view, a particle-free gas jet and an ion beam provided by the ion source unit,

FIG. 3b shows, by way of example, in a cross sectional side view, trajectories of ions from the corona discharge towards the filter element,

FIG. 4a, shows, by way of example, radial distribution of ion current density from a corona electrode,

FIG. 4b shows, by way of example, angular distribution of ion current density from the corona electrode,

FIG. 5 shows, by way of example, in a three dimensional view, a filtering apparatus, which comprises an array of ion sources,

FIG. 6 shows, by way of example, in a cross sectional side view, a filtering apparatus, which comprises an auxiliary field electrode, and

FIG. 7 shows, by way of example, in a cross sectional side view, a filtering apparatus, which comprises an auxiliary field electrode, and a transverse duct portion.

### DETAILED DESCRIPTION

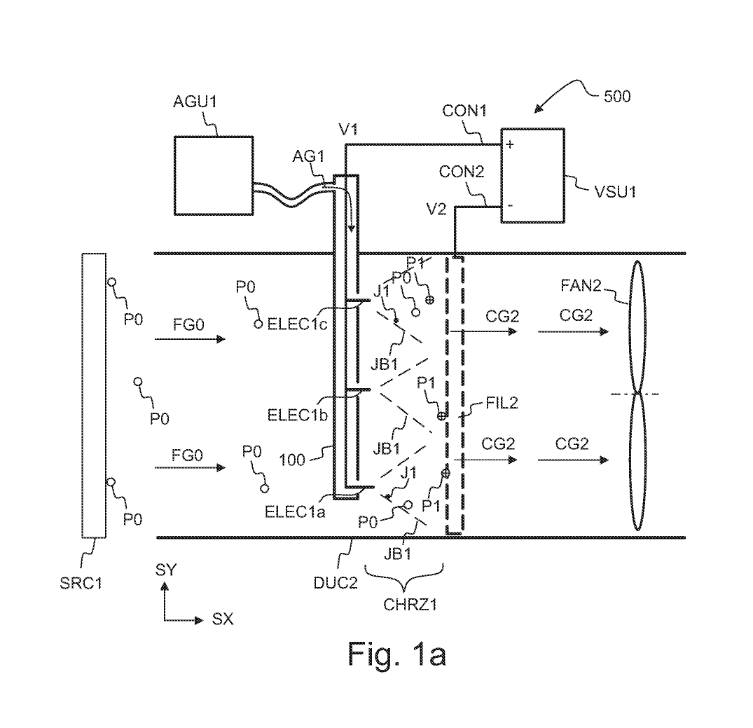

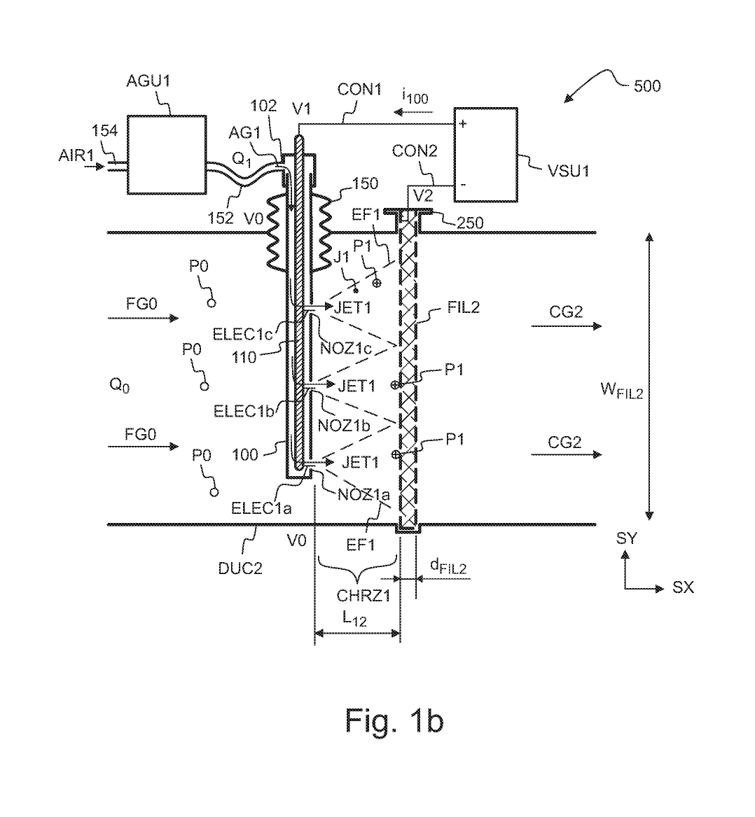

Referring to FIGS. 1a and l b, the filtering apparatus 500 may comprise a duct DUC2, a filter element FIL2, an ion source 100, and a charging zone CHRZ1. The filtering apparatus 500 may be arranged to remove particles P0 from the particle-laden gas FG0. The filtering apparatus 500 may be arranged to provide cleaned gas CG2 by charging the particles P0 and by collecting the charged particles P1 to the filter element FIL2. The particle-laden gas FG0 may be guided to the filter element FIL2 via the duct DUC2. The ion source 100 may provide one or more ion beams JB1. The particles P0 of the particle-laden gas FG0 may be charged by the ion beams JB1. The charging of the particles may take place in the charging zone CHRZ1. The filtering apparatus 500 may convert neutral particles P0 into charged particles P1 by exposing the particles P0 to ions J1 of the ion beam JB1. An ion J1 of the beam JB1 may charge a particle P0 by transferring a charge between the ion J1 and the particle P0. The charged particles P1 may be pushed and drawn towards the filter element FIL2 by an electric field EF1. The charged particles P1 may be collected to the filter element FIL2. The particle-laden gas FG0 may be guided to the filter element FIL2. The filtering apparatus 500 may provide cleaned gas CG2 by removing at least a part of the particles P0, P1 of the particle-laden the gas FG0. The gas phase of the flow FG0 may be guided through the filter element FIL2. The filter element FIL2 may let through the gas phase of the flow FG0. The filter element FIL2 may discharge cleaned gas CG2 to a downstream duct of the apparatus 500. The mass concentration of particles downstream the filter FIL2 may be e.g. smaller than 1% of the mass concentration of particles upstream the filter FIL2.

The cleaned gas CG2 may be discharged e.g. into the atmosphere. The cleaned gas CG2 may be discharged e.g. into a ventilation system.

The filter element FIL2 may have an electrically conductive permeable structure. The filter element FIL2 may comprise e.g. metal wire mesh. The filter element FIL2 may comprise e.g. knitted wire mesh, which comprises electrically conductive wire. The wire mesh may be optionally supported between supporting grids. The filter element FIL2 may comprise e.g. a metallic honeycomb structure. The filter element FIL2 may comprise e.g. a perforated metal plate. The filter element FIL2 may comprise e.g. electrically conducive carbon fibers. The filter element FIL2 may comprise e.g. fibrous electrically conductive plastic. The filter element FIL2 may have a thickness d_{FIL2} in the direction SX of the flow. The thickness d_{FIL2} may be e.g. in the range of 1 mm to 50 mm. The thickness d_{FIL2} may be e.g. in the range of 5 mm to 50 mm. The thickness d_{FIL2} may be e.g. in the range of 10 mm to 50 mm. Increasing the thickness d_{FIL2} may improve e.g. the capability to collect oil particles and/or to store collected oil particles.

The flow resistance of the filter element FIL2 may be relatively low, as the particles P1 are collected to the filter element FIL2 mainly by the electric field EF1. The pores or openings of the filter element FIL2 may be substantially larger than the size of the particles P1. The filter element FIL2 may be selected such that the flow resistance of the filter element FIL2 is e.g. lower than 1 kPa at the superficial gas velocity of 1 m/s (i.e. the pressure drop over the filter element FIL2 may be e.g. lower than 1 kPa at the superficial gas velocity of 1 m/s). The pressure drop over the filter element FIL2 may even be lower than 100 Pa at the superficial gas velocity of 1 m/s. The low pressure drop may e.g. reduce electrical power needed for operating the fan FAN2.

The ion source 100 may comprise one or more corona electrodes ELEC1 (e.g. ELEC1a, ELEC1b, ELEC1c). The corona electrode ELEC1 may be e.g. a needle electrode or a wire electrode. The corona electrode ELEC1 may generate ions J1 by a corona discharge DSR1. The filtering apparatus 500 may be arranged to accelerate and draw the ions J1 towards the filter element FIL2 by an electric field EF1. The ions J1 drifting towards the filter element FIL2 in the electric field EF1 may together form an ion beam JB1. The drifting ions J1 generated in a single corona discharge DSR1 may together form the ion beam JB1.

The filtering apparatus 500 may comprise a voltage source VSU1 for generating the electric field EF1, together with a corona electrode and with the filter element. The voltage source VSU1 may provide a voltage V1 to the corona electrode ELEC1, and a voltage V2 to the filter element FIL2. The voltage V1 may be applied to the corona electrode ELEC1 e.g. via a conductor CON1. The voltage V2 may be applied to the filter element FIL2 e.g. via a conductor CON2. The apparatus 500 may comprise a high voltage feedthrough 150. The feedthrough 150 may guide a corona current i₁₀₀ from the voltage source VSU1 to the corona electrode(s) through the wall of the duct DUC2. The voltage V1 may be applied to the corona electrode(s) ELEC1 via the feedthrough 150.

The voltage source VSU1 may apply a voltage difference V1−V2 between the corona electrode ELEC1 and the filter element FIL2, so as to generate the corona discharge DSR1 and the electric field EF1. The total ion current of the ion beam JB1 may depend on the voltage difference V1−V2. The local ion current density of the ion beam JB1 at a given point (x,y,z) may depend on the voltage difference V1−V2.

Using a high voltage difference V1−V2 may improve particle collection efficiency. The voltage difference V1−V2 may be e.g. in the range of 80% to 99% of the dielectric breakdown voltage of the cleaned gas CG1. The voltage difference V1−V2 may be e.g. in the range of 90% to 95% of the dielectric breakdown voltage of the cleaned gas CG1. Keeping the voltage difference V1−V2 below the dielectric breakdown voltage of the cleaned gas CG1 may e.g. reduce a risk of igniting a fire in the apparatus 500.

The distance L₁₂ between the corona electrode ELEC1 and the filter element FIL2, and the distance between adjacent corona electrodes ELEC1 may be selected such that the ion beams JB1 provided by the different corona electrodes may together cover a large fraction of the area of the filter element FIL2, so as to provide high collection efficiency.

The distance L₁₂ between the corona electrode ELEC1 and the filter element FIL2, the transverse distance between adjacent corona electrodes ELEC1, the shape of the corona electrode ELEC1, the three-dimensional shape of the surface of the filter element FIL2 and/or the properties of the particle-laden gas may have an effect on the angular width (θ₁) of the ion beam JB1.

The particles P0 of the stream FG0 may be exposed to the ion beam JB1 in the charging zone CHRZ1. The charging of the particles may take place in the charging zone CHRZ1. The charging zone CHRZ1 may be defined e.g. by the ion source, by the filter element FIL2, and by the duct DUC2. The charging zone CHRZ1 may be located between the ion source 100 and the filter element FIL2.

The corona electrode ELEC1 of the ion source 100 may be protected by protective gas AG1. The protective gas AG1 may be substantially particle-free. The ion source 100 may comprise a nozzle NOZ1 for forming a gas jet JET1 from the particle-free gas AG1. The gas jet JET1 may protect the corona electrode ELEC1 e.g. from particles P0, from moisture, and/or from corrosion. The gas jet JET1 may be formed from the substantially particle-free gas AG1. The corona discharge DSR1 may operate in a particle-free region. The tip of a corona needle ELEC1 may be completely surrounded by the substantially particle-free gas AG1 of the gas jet JET1 during operation of the apparatus 500. The corona electrode ELEC1 may be located inside the nozzle NOZ1. The tip of a corona needle ELEC1 may be located inside the nozzle NOZ1.

The corona electrode ELEC1 may be galvanically connected to a conductive element 110. The corona electrode ELEC1 may be mechanically supported by the conductive element 110. The conductive element 110 may support the corona electrode ELEC1 such that the tip of the corona electrode ELEC1 may be located substantially in the center of the nozzle NOZ1. The ion source 100 may comprise a sheath 120. The conductive element 110 may be located inside the sheath 120. The sheath 120 may comprise an orifice, which may operate as the nozzle NOZ1. The sheath 120 may be e.g. an electrically insulating tube. The sheath 120 may be e.g. a ceramic tube.

The ion source 100 may comprise one or more corona electrodes ELEC1, ELEC1a, ELEC1b, ELEC1c. The ion source 100 may comprise one or more nozzles NOZ1. Each nozzle NOZ1 may provide a gas jet JET1 for protecting a corona electrode.

The particle-free gas AG1 may be provided e.g. by a gas supply unit AGU1. The particle-free gas AG1 may be e.g. air, water vapor, carbon dioxide, nitrogen, or a gas mixture.

The gas supply unit AGU1 may also comprise e.g. an electrostatic filter and/or a fibrous filter for generating substantially particle-free gas AG1 from ambient air AIR1. The gas supply unit AGU1 may comprise a pump for providing a flow of particle-free gas AG1. The gas supply unit AGU1 may comprise an intake 154 for guiding ambient air AIR1 to the unit AGU1. The particle-free gas AG1 may be guided to an inlet 102 of the ion source 100 e.g. via a tube 152. The tube 152 may be electrically insulating.

The total flow rate Q₁ of the protective gas AG1 of the apparatus may be e.g. in the range of 0.1% to 1% of the total flow rate Q₀ of the particle-laden gas FG0. The flow rate of protective gas through a single nozzle NOZ1 may be e.g. in the range of 5 to 30 standard liters per minute. The flow rate protective gas through a single nozzle may be e.g. in the range of 5 to 10 standard liters per minute.

The total flow rate Q₁ of the protective gas AG1 of the apparatus may be e.g. smaller than 1% of the total flow rate Q₀ of the particle-laden gas FG0. The total flow rate Q₁ of the protective gas AG1 of the apparatus may be e.g. in the range of 0.01% to 1% of the total flow rate Q₀ of the particle-laden gas FG0.

The particles P0 may be suspended in the gas FG0. The particles P0 may be called as aerosol particles. The aerosol particles P0 may be generated by a particle source SRC1. The particle source SRC1 may comprise e.g. a fireplace, an oven, and/or a barbeque grill. The particle-laden gas FG0 may comprise e.g. smoke and/or small droplets of oil.

The particle-laden gas FG0 may be guided from the particle source SRC1 to the filtering apparatus 500 e.g. via a ventilation duct.

The size of the collected particles P0, P1 may be e.g. smaller than 5 μm, or even smaller than 2 μm.

A significant fraction of the particles P0 may comprise e.g. cooking oil. The filter element FIL2 may be wetted with cooking oil during operation. The oil layer may improve adhesion of the particles to the filter element FIL2.

The apparatus may be arranged to charge the particles by unipolar charging. The charge of the particles P1 may be unipolar. Substantially all charged particles P1 may have positive charge. Alternatively, substantially all charged particles P1 may have negative charge.

The charged particles P1 may be neutralized after they have adhered to the filter element FIL2.

The filter element FIL2 may be optionally cleaned by washing. The apparatus 500 may optionally comprise a washing unit for cleaning the filter element FIL2 without removing it. The apparatus 500 may also comprise an opening mechanism for removing and/or replacing the filter element FIL2. The apparatus 500 may comprise e.g. a hatch or cover 250, which may be opened and closed for removing and/or replacing the filter element FIL2. The filter element FIL2 may be removed, washed, and inserted back to the apparatus 500 after the washing. A first (contaminated) filter element FIL2 may be replaced with a second (clean) filter element FIL2.

L₁₂ may denote a distance between a corona electrode ELEC1 and the filter element FIL2. W_{FIL2} may denote an effective width of a gas permeable portion of the filter element FIL2.

The inner surface of the duct DUC2 may be electrically conductive. The surface of the duct DUC2 may be at a voltage V0. The potential V0 may be e.g. substantially equal to the ground voltage. The voltage V0 may be e.g. equal to the voltage V2 of the filter element FIL2.

The apparatus 500 may optionally comprise a fan FAN2 for causing a flow Q₀ of the particle-laden gas FG0 to the filter element FIL2. The fan FAN2 may cause the flow of gas CG2 through the filter element FIL2. The fan FAN2 may be e.g. an axial fan or a centrifugal fan. The particle source SRC1 may comprise a fan for causing the flow Q₀ of the particle-laden gas FG0.

SX, SY, and SZ denote orthogonal directions.

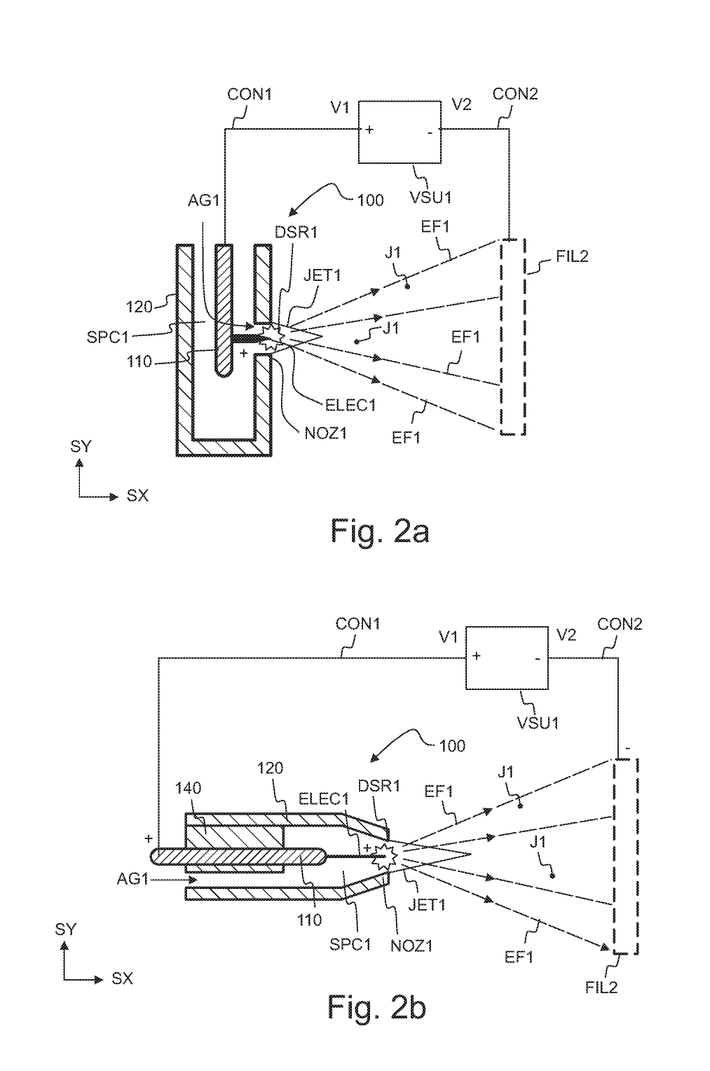

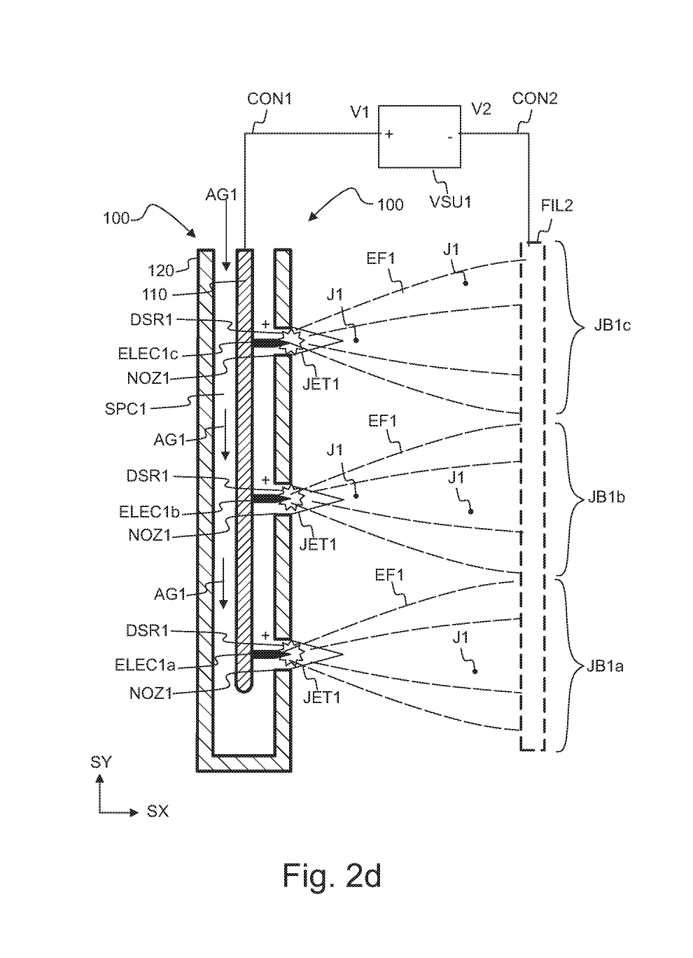

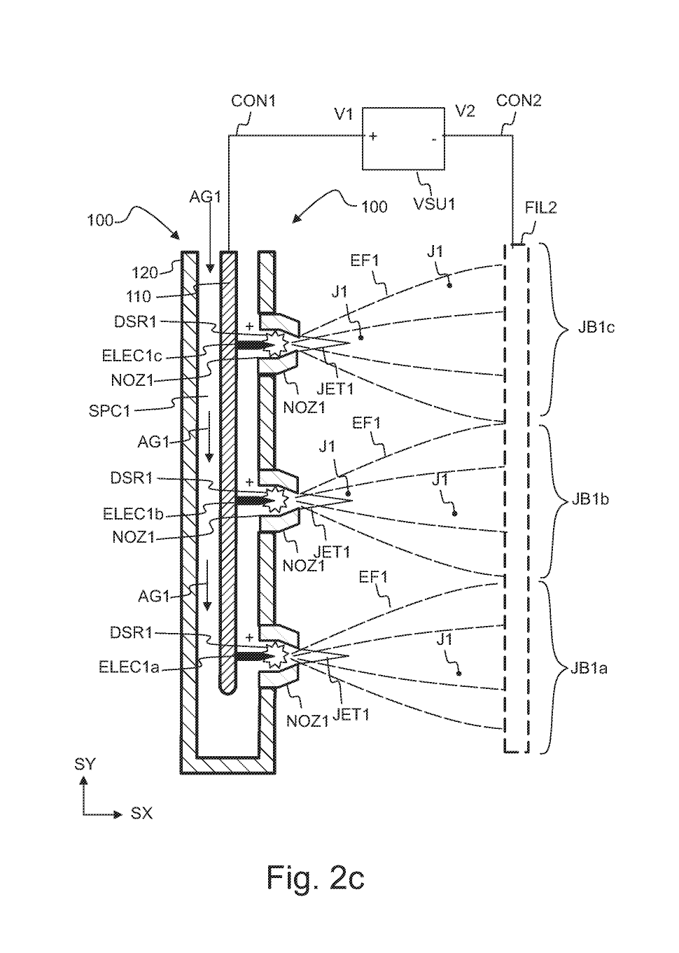

Referring to FIG. 2a, the ion source 100 of the apparatus 500 may comprise one or more corona electrodes ELEC1 (e.g. ELEC1a, ELEC1b, ELEC1c). The ion source 100 may comprise a conductor element 110 for conducting corona current to the electrode ELEC1. The conductor element 110 may also mechanically support one or more electrodes ELEC1 (e.g. ELEC1a, ELEC1b, ELEC1c). The electrode ELEC1 may be located inside a sheath 120. The sheath 120 may comprise an orifice, which may be arranged to operate as a nozzle NOZ1. The nozzle NOZ1 may be arranged to provide a gas stream JET1, which may protect the electrode ELEC1 from particles, moisture and corrosion. The nozzle NOZ1 may form a substantially particle-free gas jet JET1.

Particle-free gas AG1 may be guided to the nozzle NOZ1 e.g. via internal space SPC1 of the sheath 120. The sheath 120 may comprise electrically insulating material, e.g. a ceramic material or plastic. The sheath 120 may comprise electrically insulating material to prevent conducting a significant electric current from the corona electrode ELEC1 via the material of the sheath 120. The ion source 100 may be arranged to operate such that less than 1% of the current i₁₀₀ received from the supply VSU1 is guided via the material of the sheath 120. For example, more than 95%, or even more than 99% of the current i₁₀₀ is conducted from the corona electrode ELEC1 to the filter element FIL2 by the ions J1 and by the charged particles P1.

When using the electrically insulating material, a large fraction of the generated ions J1 may be drawn out of the nozzle NOZ1 so as to form the ion beam JB1.

The sheath 120 may be e.g. a ceramic tube. The sheath 120 may be e.g. a ceramic electrically insulating tube, which has a closed end and one or more orifices. Ceramic material may provide e.g. a dimensionally stable and incombustible structure.

The sheath 120 may be e.g. a polymer tube. The sheath 120 may be e.g. a plastic electrically insulating tube, which has a closed end and one or more orifices. Polymer material may provide e.g. a shock proof and impact resistant structure.

The sheath 120 may also be formed as a combination of electrically conductive and electrically insulating parts. The sheath 120 may comprise composite material, e.g. polymer reinforced with glass fibers or ceramic fibers.

Referring to FIG. 2b, the sheath 120 and the electrode ELEC1 may also form a concentric arrangement. A part of the sheath and the electrode ELEC1 may also form a concentric arrangement. The electrode ELEC1 and the gas jet (JET1, JET2) may be substantially parallel with an axis of a tubular sheath. The ion source 100 may optionally comprise one or more spacers 140 for supporting the electrode ELEC1 and/or a conductor element 110. The spacer 140 may define the position of the electrode ELEC1 and/or the position of the element 110 with respect to the sheath 120.

FIG. 2c shows, by way of example, an ion source 100, which comprises a several corona electrodes ELEC1a, ELEC1b, ELEC1c. A first electrode ELEC1a may provide a first electron beam JB1a. A second electrode ELEC1b may provide a second electron beam JB1b. A third electrode ELEC1c may provide a third electron beam JB1c. Each electrode ELEC1a, ELEC1b, ELEC1c may be protected by particle-free gas jet JET1. The ion source 100 may comprise several nozzles for providing the protective gas jets JET1 for the electrodes. The ion source 100 may be arranged to distribute the particle-free gas flow AG1 to several nozzles NOZ1. The ion source 100 may be arranged to distribute the particle-free gas flow AG1 to the nozzles NOZ1 such that the flow rates of the jets JET1 are substantially equal. For example, the free cross sectional area of the internal space SPC1 of the ion source 100 may be greater than or equal to the sum of the cross sectional areas of the orifices of the nozzles, so as to evenly distribute the flow rates of the jets JET1. The orifices of the nozzles may have substantially equal cross section, so as to evenly distribute the flow rates of the jets JET1.

The electrodes ELEC1a, ELEC1b, ELEC1c may be supported by a common conductor element 110.

Referring to FIG. 2d, the nozzles NOZ1 may concentrically surround each electrode ELEC1a, ELEC1b, ELEC1c, e.g. in order to improve protection of the electrodes and/or in order to minimize total flow rate of the particle-free gas AG1. For example, nozzle portions may be attached to a tubular portion so as to form a sheath 120 which comprises the nozzles NOZ1.

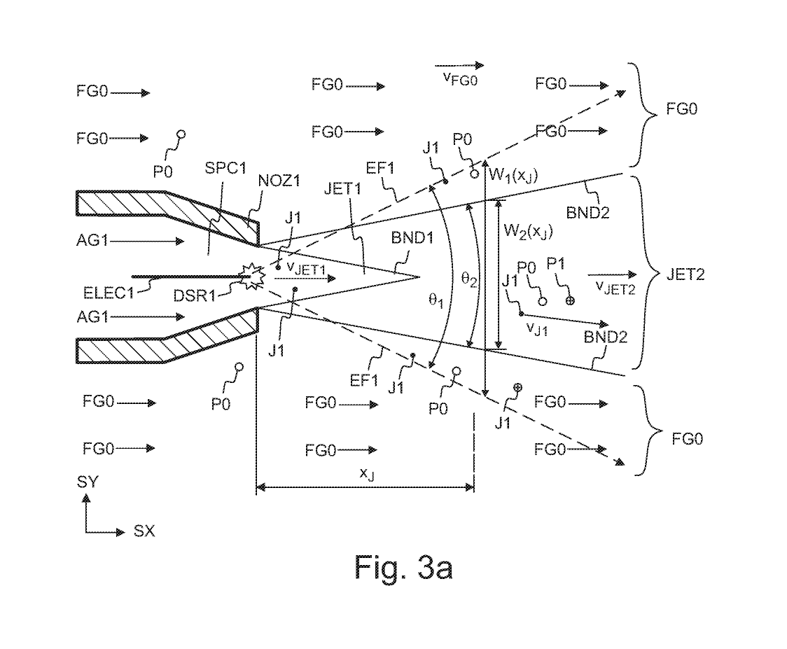

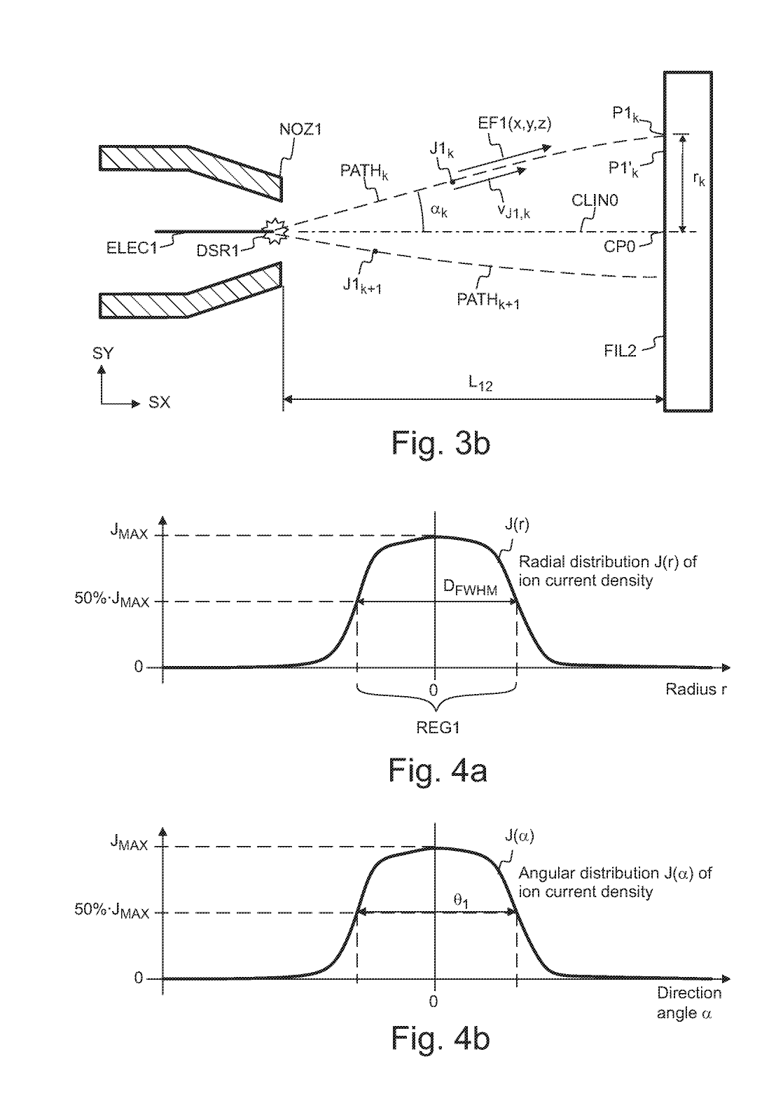

Referring to FIG. 3a, the nozzle NOZ1 may form two concentric gas jets JET1, JET2. The nozzle NOZ1 may form a substantially particle free primary jet JET1, and a particle-laden second jet JET2. The particle-laden second jet JET2 may be formed as a mixture of the particle laden gas FG0 and the particle-free gas of the primary jet JET1. The second jet JET2 may concentrically surround the primary jet JET1.

The nozzle NOZ1 may form the primary gas jet JET1 for protecting the corona electrode ELEC1. The primary gas jet JET1 may consist of particle-free gas AG1. The primary jet JET1 may have a boundary BND1. Gas AG1 inside the boundary BND1 may be substantially particle-free.

The velocity v_{JET1} of the primary jet JET1 may be higher than the velocity v_{FG0} of the particle-laden gas FG0. A large velocity difference (v_{JET1}−V_{FG0}) between the primary jet JET1 and the particle-laden gas flow FG0 may enhance mixing. The gas of the primary jet JET1 may be mixed with the particle laden gas FG0. The primary jet JET1 and the particle-laden gas FG0 may together form a secondary gas jet JET2, which is formed as a mixture of the particle laden gas FG0 and the gas of the primary jet JET1. The primary jet JET1 may be separated from the secondary jet JET2 by the inner boundary BND1.

The secondary jet JET2 may improve charging efficiency by causing mixing of the particle-laden gas with the ions of the ion beam J1.

The direction of the primary jet JET1 may be substantially parallel with the direction of movement of the particle-laden gas FG0 so as to minimize consumption of the protective gas AG1, in order to efficiently protect the electrode ELEC1, and/or in order to provide stable operation.

The primary jet JET1 may be directed towards the filter element FIL2 e.g. in order to maximize the fraction of generated ions J1, which contribute to forming the ion beam JB1. The central axis of the primary jet JET1 may be substantially parallel with the central axis of the ion beam JB1.

The central axis of the ion beam JB1 may be e.g. substantially parallel with the direction SX of the particle laden gas flow FG0.

The secondary jet JET2 may have an outer boundary BND2. The secondary jet JET2 may be formed as a mixture of the protective gas and the particle-laden gas. The secondary jet JET2 may comprise neutral particles P0 and/or charged particles P1.

The corona discharge DSR1 may generate ions J1, which may be drawn at a velocity v_{J1} towards the filter element FIL2 by the electric field EF1. The ions J1 may together form an ion beam JB1. The particles P0 may be charged by exposing them to the ions J1 of the ion beam JB1. A part of the ions J1 may be drawn through the boundary BND1 to the secondary jet JET2, which comprises particles P0. A part of the ions J1 may be drawn through the boundary BND1 to the particle-laden gas flow FG0. The divergence angle θ₂ of the jet JET2 may be e.g. in the range of 10° to 30°. The divergence angle θ₁ of the ion beam JB1 may be e.g. in the range of 15° to 90°. The divergence angle θ₁ of the ion beam JB1 may be larger than the divergence angle θ₂ of the jet JET2. The width W₁(xⱼ) of the ion beam JB1 (e.g. in direction SY) at a longitudinal position x_{J} may be larger than the width W₂(xⱼ) of the secondary jet JET2 at said longitudinal position x_{J}.

The particles P0 may be exposed to the ions J1 of the ion beam JB1. The ions J1 may have a large velocity v_{J1} with respect to velocity of the particles P0. To the first approximation, the charging efficiency for converting neutral particles P0 to charged particles P1 at a given location (x,y,z) may be proportional to the ion current density j(x,y,z) of the ion beam JB1 at said location (x,y,z).

Referring to FIG. 3b, the electric field EF1 may have a magnitude EF1(x,y,z) at a position specified by coordinates (x,y,z). An ion J1ₖ associated with an identifier k may have a velocity v_{J1,k}. The velocity of the ion J1ₖ at the point (x,y,z) may be substantially proportional to the magnitude EF1(x,y,z) of the electric field EF1 at said point (x,y,z). The direction of movement of the ion J1ₖ at the point (x,y,z) may be substantially parallel with the direction of the electric field EF1 at said point (x,y,z).

The electric field EF1 may move the ion J1ₖ along a trajectory PATHₖ. The trajectory PATHₖ may be curved. The ion J1ₖ may impinge on the filter FIL2 at a point P1ₖ. rₖ may denote the distance of the point P1ₖ from a center point CP0. The direction of movement of the ion J1ₖ at the point (x,y,z) may be specified e.g. by an angle αₖ. A second ion J1ₖ+1 may have a second trajectory PATHₖ.

The ion J1ₖ may impinge on a particle P0, and may convert the particle P0 into a charged particle P1. The charged particle P1 may impinge on the filter FIL2 at a point P1′ₖ which may be close to the point P1ₖ. To the first approximation, the trajectories of the charged particles may be substantially similar to the trajectories of the ions. To the first approximation, the spatial distribution of particles P1 collected on the filter element FIL2 may substantially correspond to the spatial distribution of ion current density J(z,y) of the ion beam JB1 at the surface of the filter element FIL2.

Referring to FIG. 4a, the ion beam JB1 may provide an ion current density distribution J(r) at the filter element FIL2. To the first approximation, the ion beam JB1 may exhibit axial symmetry. The symbol r may denote a radial distance of a point from the centerline CLIN0 of the ion beam JB1.

The ion current density distribution J(r) may have a width D_{FWHM} at the position of the filter element FIL2, in a reference situation where the particle concentration is zero. REG1 may denote an exposed portion of the surface of the filter element FIL2, which would be effectively exposed to the ion beam JB1 in a reference situation where the particle concentration would be zero. The width D_{FWHM} may mean the full width defined by the two points where ion current density is 50% of the maximum value of the ion current density. The width D_{FWHM} may refer to the FWHM width. FWHM means full width at half maximum.

Each corona electrode ELEC1 may provide an exposed region REG1. An exposed region of the filter element FIL2 may mean a region which is effectively exposed to ions JB1 of an ion beam JB1. The exposed regions REG1 may be adjacent to each other. The apparatus 500 may comprise several corona electrodes ELEC1. The positions of the corona electrodes ELEC1 may be selected such that the exposed regions REG1 may together effectively cover the whole gas-permeable area of the filter element FIL2. The exposed regions REG1 may together cover e.g. more than 95% of the gas-permeable area of the filter element FIL2. The direction SX of the flow FG0 may be perpendicular to the gas-permeable area. The gas-permeable area has a width W_{FIL2}. The gas-permeable area means the projection of the gas-permeable portion of the filter element FIL2 in a plane defined by the directions SY and SZ, wherein the direction SX of the flow FG0 may be perpendicular to the gas-permeable area.

Referring to FIG. 4b, the ion current density of the ion beam JB1 may have an angular distribution J(α). The angular ion current density distribution J(α) may have an angular width θ₁. The angular width θ₁ may mean the full angular width defined by the two points where ion current density is 50% of the maximum value of the ion current density. The width θ₁ may refer to the angular FWHM width. The angular FWHM width θ₁ may be measured e.g. at a distance of 10 mm from the electrode ELEC1. The angular FWHM width θ₁ of the ion beam JB1 may be e.g. in the range of 15° to 90° at the distance of 10 mm from the electrode ELEC1. The angular FWHM width θ₁ of the ion beam JB1 may be e.g. smaller than 90° at the distance of 10 mm from the electrode ELEC1. The limited width of the ion beam JB1 may e.g. facilitate controlled charging of the particles. The limited width of the ion beam may e.g. facilitate controlling the spatial ion current distribution at the surface of the filter element. The limited width of the ion beams may facilitate controlling the spatial ion current distribution at the surface of the filter element when using several corona electrodes simultaneously. The limited width of the ion beams may reduce spatial variation of ion current density at the surface of the filter element. The limited width of the ion beam JB1 may e.g. reduce electric power needed for effective charging and collecting of the particles.

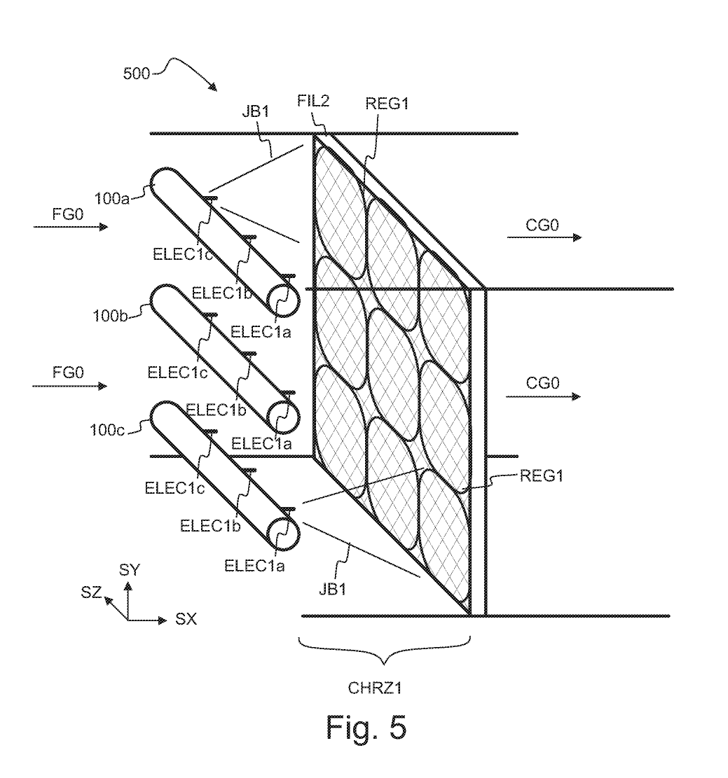

Referring to FIG. 5, the apparatus 500 may comprise one or more ion sources 100a, 100b, 100c. An ion source may comprise one or more corona electrodes ELEC1a, ELEC1b, ELEC1c. The corona electrodes of the ion source units 100a, 100b, 100c may be arranged e.g. as two dimensional array. The corona electrodes may generate several corona discharges simultaneously. The positions of the corona electrodes and the distance L₁₂ between the corona electrodes and the filter element FIL2 may be selected such that a significant fraction of the particles P0 may be charged by the ion beams JB1. The positions of the corona electrodes and the distance L₁₂ between the corona electrodes and the filter element FIL2 may be selected such that the total mass of the particles P1 charged by the ion beams JB1 may be e.g. greater than 90% of the total mass of the particles P0 of the gas flow FG0. The positions of the corona electrodes and the distance L₁₂ between the corona electrodes and the filter element FIL2 may be selected such that e.g. more than 90% of the total mass of the particles P0 may be collected to the filter element FIL2.

The positions of the corona electrodes ELEC1 may be selected such that the exposed regions REG1 may together effectively cover the whole gas-permeable area of the filter element FIL2.

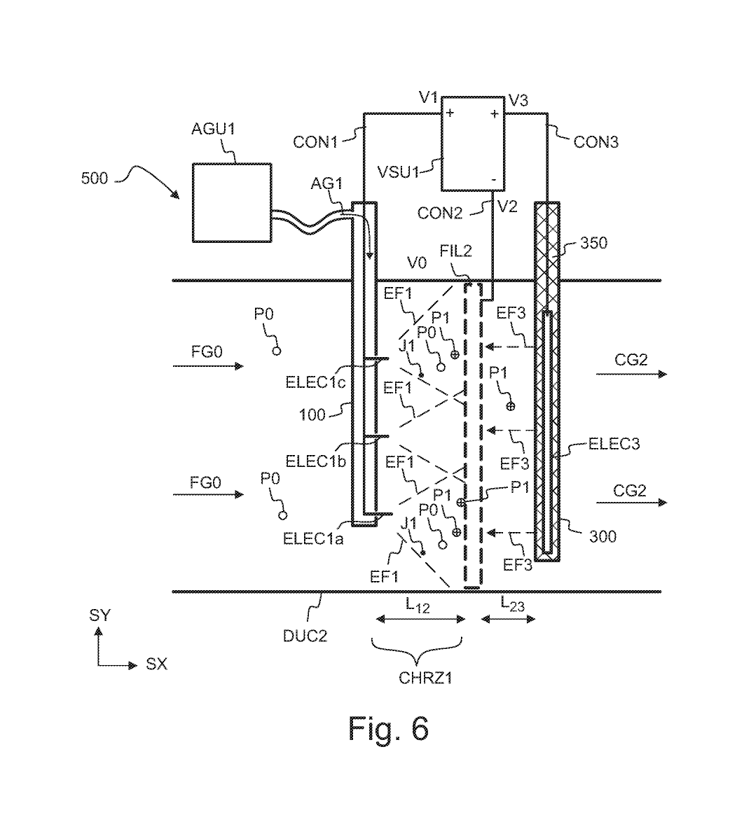

Referring to FIG. 6, a small part of the charged particles P1 may sometimes pass through the filter element FIL2 from the upstream side to the downstream side of the filter element FIL2. The apparatus 500 may optionally comprise an auxiliary electrode ELEC3 for generating an auxiliary electric field EF3. The auxiliary electric field EF3 may be generated between the filter element FIL2 and the auxiliary electrode ELEC3. The auxiliary electric field EF3 may push the escaped charged particles P1 in the reverse direction (−SX). The auxiliary electric field EF3 may draw the charged particles P1 from the downstream side of the filter element FIL2 to the filter element FIL2.

The auxiliary electrode ELEC3 does not need to provide an electric current. The auxiliary electrode ELEC3 may be fully surrounded by an insulator 350, e.g. in order to prevent electric discharges in the vicinity of the auxiliary electrode ELEC3. The apparatus 500 may comprise a voltage source VSU1 for applying a voltage difference V3−V2 between the auxiliary electrode ELEC3 and the filter element FIL2. The voltage V3 may be coupled to the auxiliary electrode ELEC3 by a conductor CON3. L23 may denote the distance between the filter element FIL2 and the auxiliary electrode ELEC3. The voltage difference V3−V2 and the distance L23 may be selected e.g. to maximize collection efficiency for charged particles P1 located downstream the filter element FIL2, while also keeping the risk of dielectric breakdown below a predetermined limit.

The voltage V3 of the auxiliary electrode ELEC3 may also be equal to the voltage V1 of the corona electrode ELEC1. The same voltage V1 may be coupled to the corona electrode ELEC1 and to the auxiliary electrode ELEC3. The voltages V1 and V3 may be provided by using the same voltage source VSU1. The distance L23 may be selected such that a sufficient downstream collection efficiency is attained when the same voltage V1 is coupled to the corona electrode ELEC1 and to the auxiliary electrode ELEC3.

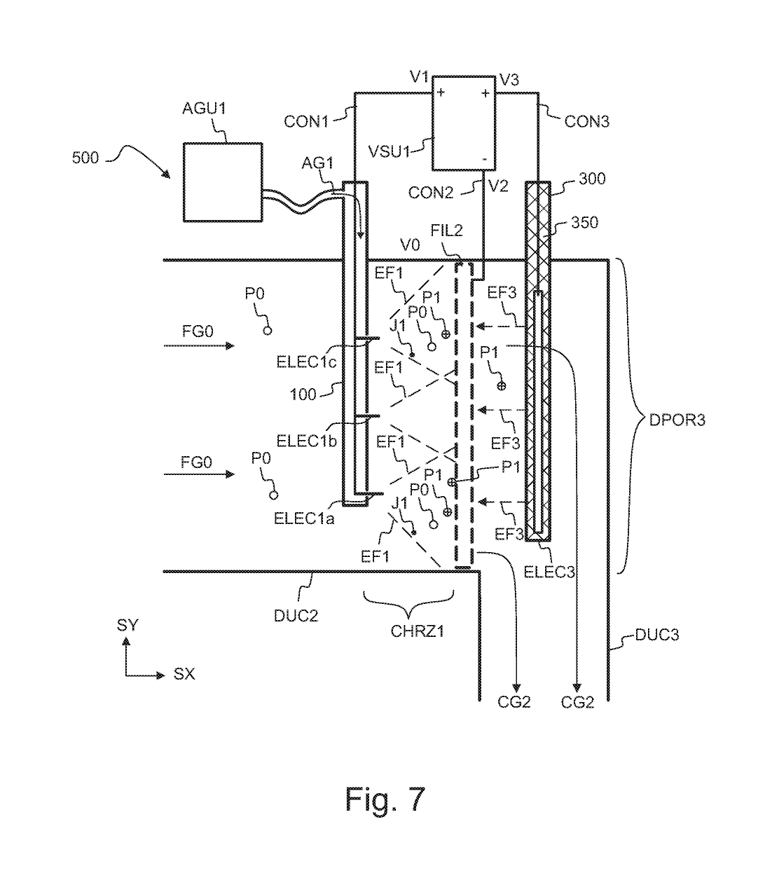

Referring to FIG. 7, the apparatus 500 may comprise a deflecting portion DPOR3 for directing the gas flow CG2 such that it has a transverse velocity component. The apparatus 500 may comprise e.g. one or more side ducts DUC3 for deflecting the gas flow CG2 to a transverse direction. The apparatus 500 may comprise e.g. one or more baffles for deflecting the gas flow CG2. The apparatus 500 may comprise one or more transverse ducts DUC3 for guiding a deflected flow. Deflecting the flow CG2 may e.g. increase residence time of the particles P1 in the space between the filter element FIL2 and the auxiliary electrode ELEC3.

The gas flow CG2 may be guided from a first filtering apparatus 500 to a second filtering apparatus 500. The first filtering apparatus 500 may comprise one or more ion sources and a filter element, and the second filtering apparatus 500 may also comprise one or more ion sources and a filter element. Connecting the first filtering apparatus 500 in series with the second filtering apparatus 500 may provide an improved filtering efficiency, when compared with the filtering efficiency of a single apparatus 500.

The filter element FIL2 may be e.g. removed and washed in a separate washing machine. The apparatus 500 may optionally a washing unit for washing the filter element FIL2 without removing the filter element FIL2. The apparatus 500 may comprise one or more channels for collecting used washing liquid and/or for guiding used washing liquid out of the apparatus 500.

The apparatus 500 may optionally a washing unit and/or gas nozzle for cleaning the outer surface of the ion sources 100.

The particle-laden gas FG0 may be optionally pre-treated e.g. by using cyclone and/or by using a prefilter, so as to reduce the concentration of large particles P0. Removing the large particles may increase the maintenance interval (i.e. the length of time between maintenance operations). The pre-treated particle-laden gas may be guided from the cyclone or prefilter to the charging zone CHRZ1.

The apparatus 500 may optionally comprise a sensor unit for measuring particle concentration upstream and/or downstream the filter element FIL2. The apparatus 500 may optionally comprise a sensor unit for measuring pressure difference between upstream and/or downstream the filter element FIL2. The apparatus 500 may optionally comprise a sensor unit for measuring flow resistance of the filter element FIL2. The apparatus 500 may be arranged to provide an alarm or an indication to a user when a measured particle concentration exceeds a predetermined limit. The apparatus 500 may be arranged to provide an alarm or an indication to a user when flow resistance of the filter element FIL2 is higher than a predetermined limit. The apparatus may comprise a sensor for measuring corona current of a corona electrode. The apparatus 500 may be arranged to provide an alarm or an indication to a user when corona current of a corona electrode is outside a predetermined range.

The apparatus 500 may comprise a detector for detecting a fire inside the flow duct DUC2. The apparatus 500 may comprise a sensor for detecting fire. The apparatus 500 may comprise e.g. temperature sensor and/or an optical sensor for detecting fire inside the flow duct DUC2. The apparatus 500 may comprise a fire extinguisher for extinguishing an internal fire.

The velocity of the particle-laden gas FG0 may be selected so as to optimize and/or improve particle collection efficiency. The apparatus 500 may optionally comprise one or more flow guiding structures to optimize and/or improve particle collection efficiency. The spatial distribution of the electric fields EF1, EF21 may be selected so as to optimize and/or improve particle collection efficiency.

Various aspects are illustrated by the following examples

### Example 1

A gas cleaning apparatus (500), comprising:
an ion source (100) to provide an ion beam (JB1),
a charging zone (CHRZ1) to form charged particles (P1) by exposing particles (P0) of a particle-laden gas (FG0) to the ion beam (JB1), and
a filter element (FIL2) to collect the charged particles (P1),
wherein the ion source (100) comprises a corona electrode (ELEC1) to generate ions (J1) by a corona discharge (DSR1), the ion source (100) is arranged to form the corona discharge (DSR1) in a protective gas (AG1), and wherein the apparatus (500) is arranged to form the ion beam (JB1) by using an electric field (EF1) to draw the generated ions (J1) from the corona discharge (DSR1) to the particle-laden gas (FG0).

### Example 2

The apparatus (500) of example 1, wherein the ion source (100) comprises a nozzle (NOZ1) for providing a substantially particle-free gas jet (JET1), and wherein the electric field (EF1) draws the generated ions (J1) from the corona discharge (DSR1) to the particle-laden gas (FG0) via the particle-free gas jet (JET1).

### Example 3

The apparatus (500) of example 2, wherein the nozzle (NOZ1) is arranged to direct the gas jet (JET1) towards the filter element (FIL2), and wherein the electric field (EF1) is arranged to draw the generated ions (J1) towards the filter element (FIL2).

### Example 4

The apparatus (500) of example 2 or 3 wherein the filter element (FIL2) comprises an electrically conductive mesh structure, the apparatus (500) is arranged to form cleaned gas (CG2) by removing the charged particles (P1) from the particle-laden gas (FG0) to the filter element (FIL2), and the apparatus (500) is arranged to guide the cleaned gas (CG2) through the mesh structure of the filter element (FIL2).

### Example 5

The apparatus (500) according to any of the examples 1 to 4, wherein the ion source (100) comprises an electrically insulating sheath (120), the sheath (120) comprises a plurality of orifices arranged to operate as nozzles (NOZ1), the ion source (100) comprises a plurality of needle electrodes (ELEC1), and each nozzle (NOZ1) is arranged to provide a substantially particle-free gas jet (JET1) for protecting the needle electrodes (ELEC1).

### Example 6

The apparatus (500) according to any of the examples 1 to 5, wherein the apparatus (500) comprises a flow guiding structure (DUC2), which is arranged to guide the particle-laden gas (FG0) to the filter element (FIL2) such that the charged particles (P1) are collected to the filter element (FIL2) and such that cleaned gas (CG2) is drawn through the filter element (FIL2).

### Example 7

The apparatus (500) according to any of the examples 1 to 6, wherein the ion source (100) comprises an electrically insulating tube (120), an opening of the tube (120) is arranged to operate as the nozzle (NOZ1), particle-free gas (AG1) is guided to the nozzle (NOZ1) via the tube (120), and a conductor (110) for guiding corona current to the corona electrode (ELEC1) is located inside the tube (120).

### Example 8

The apparatus (500) according to any of the examples 1 to 7, wherein the apparatus (500) is arranged to supply substantially particle-free gas (AG1) to one or more ion sources (100) at a first flow rate (Q1), and wherein a ratio (Q1/Q0) of the first flow rate (Q1) of the particle-free gas (AG1) to the flow rate (Q0) of the particle-laden gas (FG0) is in the range of 0.1% to 1%.

### Example 9

The apparatus (500) according to any of the examples 1 to 8, comprising an auxiliary electrode (ELEC3), which is positioned downstream the filter element (FIL2), wherein the auxiliary electrode (ELEC3) is arranged to generate an auxiliary electric field (EF3) for collecting particles (P1) which have passed through the filter element (FIL2).

### Example 10

The apparatus (500) according to any of the examples 1 to 9, wherein an angular width (θ₁) of the ion beam (JB1) is smaller than or equal to 90° at the distance of 10 mm from the corona electrode (ELEC1).

### Example 11

A method for separating particles (P0,P1) from particle-laden gas (FG0) by using the apparatus (500) according to any of the examples 1 to 10.

### Example 12

A method for separating particles (P0,P1) from particle-laden gas (FG0), said method comprising:
providing an ion beam (JB1) by using an ion source (100),
forming charged particles (P1) by exposing particles (P0) of a particle-laden gas (FG0) to the ion beam (JB1), and
collecting the charged particles (P1) to a filter element (FIL2),
wherein the ion source (100) comprises a corona electrode (ELEC1) to generate ions (J1) by a corona discharge (DSR1), the corona discharge (DSR1) is formed in a protective gas (AG1), and wherein the generated ions (J1) are drawn from the corona discharge (DSR1) to the particle-laden gas (FG0) by an electric field (EF1).

### Example 13

The method of example 12, comprising providing a substantially particle-free gas jet (JET1), and drawing the generated ions (J1) from the corona discharge (DSR1) to the particle-laden gas (FG0) via the particle-free gas jet (JET1) by using the electric field (EF1).

### Example 14

The method according to any of the examples 11 to 13, comprising directing the gas jet (JET1) towards the filter element (FIL2) by using a nozzle (NOZ1), and drawing the generated ions (J1) towards the filter element (FIL2) by using the electric field (EF1).

### Example 15

The method according to any of the examples 11 to 14, wherein the filter element (FIL2) comprises an electrically conductive mesh structure, wherein the method comprises forming cleaned gas (CG2) by collecting the charged particles (P1) from the particle-laden gas (FG0) to the filter element (FIL2), and drawing the cleaned gas (CG2) through the mesh structure of the filter element (FIL2).

### Example 16

The method according to any of the examples 11 to 15, comprising supplying particle-free gas (AG1) to one or more ion sources (100) at a first total flow rate (Q₁), and wherein a ratio (Q₁/Q₀) of the first total flow rate (Q₁) of the particle-free gas (AG1) to the flow rate (Q₀) of the particle-laden gas (FG0) is in the range of 0.1% to 1%.

### Example 17

The method according to any of the examples 11 to 16, comprising supplying particle-free gas (AG1) to a first nozzle (NOZ1) of an ion source (100) and to a second nozzle (NOZ1) of the ion source (100) such that the flow rate of particle-free gas (AG1) through the first nozzle (NOZ1) is substantially equal to the flow rate of particle-free gas (AG1) through the second nozzle (NOZ1).

### Example 18

The method according to any of the examples 11 to 17, comprising providing substantially particle-free gas (AG1) by cleaning ambient air (AIR1).

### Example 19

The method according to any of the examples 11 to 18, wherein the particles (P0,P1) comprise cooking oil.

For the person skilled in the art, it will be clear that modifications and variations of the devices and the methods according to the present invention are perceivable. The figures are schematic. The particular embodiments described above with reference to the accompanying drawings are illustrative only and not meant to limit the scope of the present disclosure, which is defined by the appended claims.

1. A gas cleaning apparatus, comprising:
an ion source to provide an ion beam,
a charging zone to form charged particles by exposing particles of a particle-laden gas to the ion beam, and
a filter element to collect the charged particles,
wherein the ion source comprises a corona electrode to generate ions by a corona discharge, the ion source is arranged to form the corona discharge in a protective gas, and wherein the apparatus is arranged to form the ion beam by using an electric field to draw the generated ions from the corona discharge to the particle-laden gas.

2. The apparatus of claim 1, wherein the ion source comprises a nozzle for providing a substantially particle-free gas jet, and wherein the electric field draws the generated ions from the corona discharge to the particle-laden gas via the particle-free gas jet.

3. The apparatus of claim 2, wherein the nozzle is arranged to direct the gas jet towards the filter element, and wherein the electric field is arranged to draw the generated ions towards the filter element.

4. The apparatus of claim 1 wherein the filter element comprises an electrically conductive mesh structure, the apparatus is arranged to form cleaned gas by removing the charged particles from the particle-laden gas to the filter element, and the apparatus is arranged to guide the cleaned gas through the mesh structure of the filter element.

5. The apparatus (500) of claim 1, wherein the ion source comprises an electrically insulating sheath, the sheath comprises a plurality of orifices arranged to operate as nozzles, the ion source comprises a plurality of needle electrodes, and each nozzle is arranged to provide a substantially particle-free gas jet for protecting the needle electrodes.

6. The apparatus (500) of claim 1, wherein the apparatus comprises a flow guiding structure, which is arranged to guide the particle-laden gas to the filter element such that the charged particles are collected to the filter element and such that cleaned gas is drawn through the filter element.

7. The apparatus of claim 1, wherein the ion source comprises an electrically insulating tube, an opening of the tube is arranged to operate as the nozzle, particle-free gas is guided to the nozzle via the tube, and a conductor for guiding corona current to the corona electrode is located inside the tube.

8. The apparatus of claim 1, wherein the apparatus is arranged to supply substantially particle-free gas to one or more ion sources at a first flow rate, and wherein a ratio of the first flow rate of the particle-free gas to the flow rate of the particle-laden gas is in the range of 0.1% to 1%.

9. The apparatus of claim 1, comprising an auxiliary electrode, which is positioned downstream the filter element, wherein the auxiliary electrode is arranged to generate an auxiliary electric field for collecting particles which have passed through the filter element.

10. The apparatus of claim 1, wherein an angular width of the ion beam is smaller than or equal to 90° at the distance of 10 mm from the corona electrode.

11. A method for separating particles from particle-laden gas by using a gas cleaning apparatus, the gas cleaning apparatus comprising:
an ion source to provide an ion beam,
a charging zone to form charged particles by exposing particles of a particle-laden gas to the ion beam, and
a filter element to collect the charged particles,
wherein the ion source comprises a corona electrode to generate ions by a corona discharge, the ion source is arranged to form the corona discharge in a protective gas, and wherein the apparatus is arranged to form the ion beam by using an electric field to draw the generated ions from the corona discharge to the particle-laden gas.

12. A method for separating particles from particle-laden gas, said method comprising:
providing an ion beam by using an ion source,
forming charged particles by exposing particles of a particle-laden gas to the ion beam, and
collecting the charged particles to a filter element,
wherein the ion source comprises a corona electrode to generate ions by a corona discharge, the corona discharge is formed in a protective gas, and wherein the generated ions are drawn from the corona discharge to the particle-laden gas by an electric field.

13. The method of claim 12, comprising providing a substantially particle-free gas jet, and drawing the generated ions from the corona discharge to the particle-laden gas via the particle-free gas jet by using the electric field.

14. The method of claim 12, comprising directing the gas jet towards the filter element by using a nozzle, and drawing the generated ions towards the filter element by using the electric field.

15. The method of claim 12, wherein the filter element comprises an electrically conductive mesh structure, wherein the method comprises forming cleaned gas by collecting the charged particles from the particle-laden gas to the filter element, and drawing the cleaned gas through the mesh structure of the filter element.

16. The method of claim 12, comprising supplying particle-free gas to one or more ion sources at a first total flow rate, and wherein a ratio of the first total flow rate of the particle-free gas to the flow rate of the particle-laden gas is in the range of 0.1% to 1%.

17. The method of claim 12, comprising supplying particle-free gas to a first nozzle of an ion source and to a second nozzle of the ion source such that the flow rate of particle-free gas through the first nozzle is substantially equal to the flow rate of particle-free gas through the second nozzle.

18. The method of claim 12, comprising providing substantially particle-free gas by cleaning ambient air.

19. The method of claim 12, wherein the particles comprise cooking oil.
